(19) United States
(12) Patent Application Publication
(10) Pub. No.: US 2012/0249776 A1
(43) Pub. Date: Oct. 4, 2012

(54) LIGHT-EMITTING DEVICE INSPECTING APPARATUS AND METHOD

(76) Inventors: Won-soo JI, Gyeonggi-do (KR); Dae-seo PARK, Gyeonggi-do (KR); Choo-ho KIM, Gyeonggi-do (KR)

(21) Appl. No.: 13/424,120

(22) Filed: Mar. 19, 2012

(30) Foreign Application Priority Data
Mar. 29, 2011 (KR) 10-2011-0028209

(51) Int. Cl. H04N 7/18; G06K 9/00

(52) U.S. Cl. 348/125; 382/141; 348/E07.085

(57) ABSTRACT

A light-emitting device inspecting apparatus for inspecting characteristics of a light-emitting device including one or more light-emission cells that emit light, the light-emitting device inspecting apparatus including a probing unit having a table on which the light-emitting device is mounted and probes that supply a current to the light-emitting device; an image obtaining unit for obtaining an image of the light-emitting device; and a determination unit for determining open/short defects of the light-emitting device by detecting light-emission of the one or more light-emission cells from brightness information of the image.

### CROSS-REFERENCE TO RELATED APPLICATIONS

This application claims the benefit of Korean Patent Application No. 10-2011-0028209, filed on Mar. 29, 2011, in the Korean Intellectual Property Office, the disclosure of which is incorporated herein in its entirety by reference.

### BACKGROUND

1. Field

The present disclosure relates to methods and apparatuses for inspecting a light-emitting device with respect to a defect affecting its electrical and optical characteristics, an outward appearance, and the like.

2. Description of the Related Art

A light-emitting device, e.g., a light-emitting diode (LED), is a semiconductor device capable of realizing various colors of light via an emission source formed at a PN junction of a compound semiconductor. The LED has a long lifetime, can be minimized, is light, has strong directivity to light, and can be driven by a small voltage. Also, the LED is highly resistant to shocks and vibrations, does not require a preheating time and a complicated driving structure, and can be packaged into various forms. Thus, LEDs may be used for various purposes.

### SUMMARY

A light-emitting device is manufactured via a series of semiconductor fabricating processes, and in this regard, an inspection process is necessary to inspect an outward appearance, electrical characteristics, and optical characteristics of a manufactured light-emitting device.

Provided are inspecting methods and apparatuses for easily performing an electrical characteristic inspection, i.e., an open/short inspection.

Provided are methods and apparatuses for simultaneously inspecting electrical characteristics and optical characteristics of a light-emitting device.

Provided are methods and apparatuses for simultaneously inspecting electrical/optical characteristics and an outward appearance of a LED.

Additional aspects will be set forth in part in the description which follows and, in part, will be apparent from the description, or may be learned by practice of the presented embodiments.

According to an aspect of the present invention, a light-emitting device inspecting apparatus inspects a characteristic of a light-emitting device including one or more light-emission cells that emit light, and includes a probing unit having a table on which the light-emitting device is mounted and probes that supply a current to the light-emitting device; an image obtaining unit for obtaining an image of the light-emitting device; and a determination unit for determining open/short defects of the light-emitting device by detecting light-emission of the one or more light-emission cells from brightness information of the image.

The light-emitting device inspecting apparatus may further include a measuring unit including an integrating sphere that is positioned above the table and collects light emitted from the light-emitting device, and a detector that detects an optical characteristic of the light-emitting device, wherein the measuring unit may determine a defect of the optical characteristic of the light-emitting device based on the detected optical characteristic.

The determination unit may divide the light-emitting device into a plurality of groups based on a result of the determination on the open/short defects, and the detected optical characteristic.

A light window may be arranged at the integrating sphere, and the image obtaining unit may obtain the image of the light-emitting device via the light window.

The determination unit may include an image processing unit for generating an inspection image for an outward appearance inspection from the image, and the determination unit may determine a defect of an outward appearance of the light-emitting device by comparing the inspection image with a pre-set reference image.

The image obtaining unit may include an imaging device; and a lens for focusing light on the imaging device after the light has passed through the light window.

The image obtaining unit may include a light amount adjuster that is positioned ahead of the lens and adjusts the amount of light that has passed through the light window.

The light-emitting device may include a multi-light emission chip in which a plurality of light-emission cells are arrayed.

The light-emitting device may include a light-emitting diode (LED) package formed by packaging a plurality of LED chips.

The light-emitting device may include a LED package formed by packaging one or more multi-light emission chips in which a plurality of light-emission cells are arrayed.

According to another aspect of the present invention, a method of inspecting a characteristic of a light-emitting device including one or more light-emission cells that emit light includes operations of supplying a current to the light-emitting device; obtaining an image of the light-emitting device; and determining open/short defects of the light-emitting device by detecting light-emission of the one or more light-emission cells from brightness information of the image.

The method may further include operations of collecting light emitted from the light-emitting device by using an integrating sphere, and detecting an optical characteristic of the light-emitting device from the collected light; and determining a defect of the optical characteristic of the light-emitting device based on the detected optical characteristic.

The method may further include an operation of dividing the light-emitting device into a plurality of groups based on a result of the determination on the open/short defects, and the detected optical characteristic.

The operation of obtaining the image may include an operation of obtaining the image of the light-emitting device via a light window arranged at the integrating sphere.

The method may further include operations of generating an inspection image for an outward appearance inspection from the image, and determining a defect of an outward appearance of the light-emitting device by comparing the inspection image with a pre-set reference image.

The light-emitting device may include a multi-light emission chip in which a plurality of light-emission cells are arrayed.

The light-emitting device may include a light-emitting diode (LED) package formed by packaging a plurality of LED chips.

The light-emitting device may include a LED package formed by packaging one or more multi-light emission chips in which a plurality of light-emission cells are arrayed.

### BRIEF DESCRIPTION OF THE DRAWINGS

These and/or other aspects will become apparent and more readily appreciated from the following description of the embodiments, taken in conjunction with the accompanying drawings of which:

FIG. 1 illustrates a configuration of a light-emitting device inspecting apparatus according to an embodiment of the present invention;

FIG. 2 illustrates an optical configuration to obtain an image of a light-emitting device;

FIG. 3 illustrates a light-emitting diode chip (LED chip) as an example of the light-emitting device to be inspected;

FIG. 4 illustrates a multi-LED chip as an example of the light-emitting device to be inspected;

FIG. 5 is a cross-sectional view of an LED package as an example of the light-emitting device to be inspected;

FIG. 6 illustrates an example of a multi-LED chip in which five LEDs are arrayed in parallel;

FIG. 7 is a graph showing measured currents according to the number of light-emission cells having an electrical open defect when a driving current is applied to the multi-LED chip of FIG. 6;

FIG. 8 illustrates an inspection image when some of light-emission cells of the multi-LED chip are electrically open;

FIG. 9 illustrates examples of the inspection image when some of the light-emission cells of the multi-LED chip are electrically open;

FIG. 10 illustrates examples of an inspection image when some of the light-emission cells of the multi-LED chip are electrically connected to create a short-circuit;

FIG. 11 corresponds to an example of a defective outward appearance of the multi-LED chip and illustrates an inspection image when an outward appearance of the multi-LED chip is damaged;

FIG. 12 corresponds to an example of a defective outward appearance of the multi-LED chip and illustrates an inspection image when a foreign substance is attached to an outward appearance of the multi-LED chip; and

FIG. 13 corresponds to an example of a defective outward appearance of the multi-LED chip and illustrates an inspection image when an encapsulation layer is defectively formed.

### DETAILED DESCRIPTION

Reference will now be made in detail to embodiments, examples of which are illustrated in the accompanying drawings, wherein like reference numerals refer to the like elements throughout. In the drawings, the size of each component may be exaggerated for clarity.

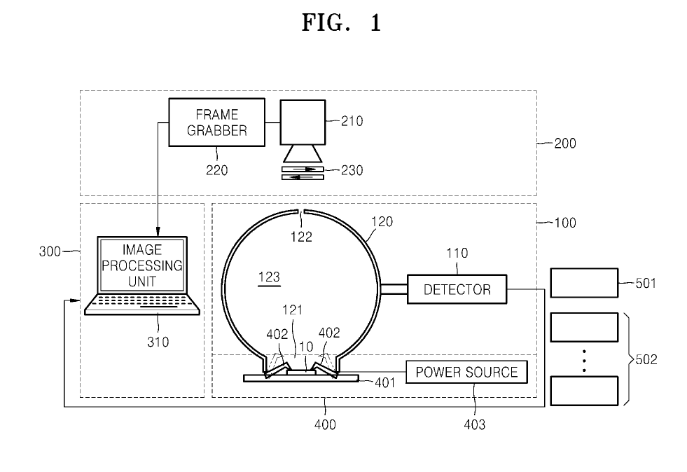

FIG. 1 illustrates a configuration of a light-emitting device inspecting apparatus according to an embodiment of the present invention.

A probing unit 400 supplies electric energy for inspection to a light-emitting device 10, and may include a table 401 on which the light-emitting device 10 is mounted, and probes 402 that is connected to a power source 403 so as to supply an inspection current to the light-emitting device 10. As illustrated in FIG. 1 by dotted lines, the probes 402 may be mounted in off positions. When the light-emitting device 10 is mounted on the table 401 by a transporting means (not shown), as illustrated in FIG. 1 by solid lines, the probes 402 contact electrode pads of the light-emitting device 10 and then supply the inspection current to the light-emitting device 10.

The light-emitting device inspecting apparatus according to the present embodiment performs an electrical open/short inspection with respect to the light-emitting device 10 by using image information of the light-emitting device 10. To do so, an image obtaining unit 200 is arranged to obtain the image information of the light-emitting device 10. The image obtaining unit 200 may have a camera 210 for capturing an image of the light-emitting device 10. Also, the image obtaining unit 200 may further have a frame grabber 220 for converting the image captured by the camera 210 into digitized image information.

In order to integrate an image obtaining process and an optical characteristic inspection, a measuring unit 100 may be further arranged in the light-emitting device inspecting apparatus. The measuring unit 100 may include an integrating sphere 120 and a detector 110. The integrating sphere 120 may include an inner cavity 123 having a round shape, and a light-incident unit 121 having an opening via which light emitted from the light-emitting device 10 enters the inner cavity 123. In order to measure an optical characteristic such as brightness, wavelength, or the like of the light-emitting device 10, the detector 110 is installed at the integrating sphere 120. An inner wall of the integrating sphere 120 is coated with a material having an excellent reflectance, so that incident light is uniformly reflected in the integrating sphere 120. Thus, dispersion of light in the integrating sphere 120 is highly uniform, and light that enters the integrating sphere 120 via the light-incident unit 121 is uniformly dispersed to the entire inner wall of the integrating sphere 120. The amount of light incident on the inner wall of the integrating sphere 120 is the same as the amount of light that enters the integrating sphere 120. Thus, if the amount of light incident on a portion of the inner wall of the integrating sphere 120 is obtained by using this relation, it is possible to obtain a total amount of light that enters the integrating sphere 120. When an area of a measured region is referred to as A, a total of a surface area of the inner wall of the integrating sphere 120 is referred to as B, and a measured amount of light is referred to as C, the total amount of light is obtained by C×(B/A). Here, the area of the measured region may be an area of a light-receiving device of the detector 110. As described above, brightness of the light-emitting device 10 may be measured from the amount of light measured by the detector 110. Also, a spectrometer may be arranged in the detector 110 so as to detect a wavelength.

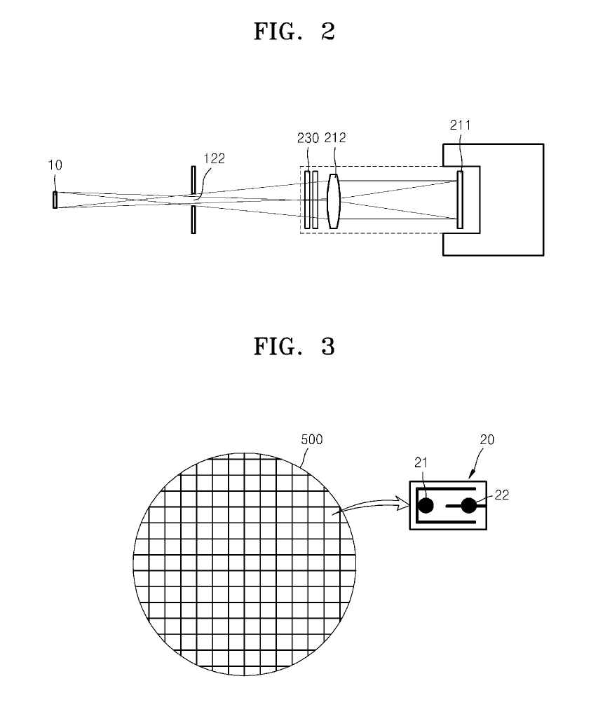

A light window 122 is arranged at the integrating sphere 120. The image obtaining unit 200 obtains the image of the light-emitting device 10 via the light window 122 arranged at the integrating sphere 120. FIG. 2 illustrates an optical configuration to obtain the image of the light-emitting device 10 via the light window 122. Referring to FIG. 2, light is emitted from the light-emitting device 10 via the light window 122. The light window 122 may have a pin hole shape with a diameter from about 2 mm to about 4 mm, but one or more embodiments of the present invention are not limited thereto. A shape and a size of the light window 122 may be appropriately set in the range that does not affect the amount of light detected by the integrating sphere 120. According to a test, when the light window 122 having a diameter of about 4 mm is formed in the integrating sphere 120 having a diameter of about 100 mm, the amount of light detected by the detector 110 is about 99.99% of the amount of light detected when the light window 122 is not formed, and thus, the light window 122 hardly affects the detection of light.

A lens 212 focuses light emitted via the light window 122 on an imaging device 211, e.g., a charge-coupled device (CCD) of the camera 210. A light amount adjuster 230 is arranged to adjust the amount of light so as to prevent the light emitted from the light-emitting device 10 from saturating the imaging device 211. The light amount adjuster 230 may be embodied by using one or more polarizing plates. Since the polarizing plate only transmits light that is polarized in a particular direction, it is possible to adjust the amount of light incident on the imaging device 211 by using the polarizing plate. Alternatively, the light amount adjuster 230 may be embodied by using other optical elements including a natural density filter (ND filter) or the like capable of adjusting the amount of light. Also, the light amount adjuster 230 may be realized by adjusting a speed of a shutter embedded in the camera 210 or may be realized by adjusting a sensitivity of the imaging device 211.

The image of the light-emitting device 10 may be photoelectrically converted by the imaging device 211 into image information to be processed by a computer after the image is digitized by the frame grabber 220.

A determination unit 300 may include an image processing unit 310. The image processing unit 310 extracts an inspection image of the light-emitting device 10 from the image information that is delivered from the image obtaining unit 200. The inspection image is necessary for an inspection of the light-emitting device 10 and may include brightness information. Also, the inspection image may include contour information of the light-emitting device 10 whose image is captured. The determination unit 300 may determine electrical open/short of the light-emitting device 10 by referring to the brightness information. Also, the determination unit 300 may compare the inspection image with a reference image, and thus, may perform an outward appearance inspection to detect damage of the light-emitting device 10, the existence of foreign substances, or the like. The determination unit 300 may determine a defect of an optical characteristic of the light-emitting device 10 by using the optical characteristic delivered from the measuring unit 100. According to the optical characteristic, the determination unit 300 may divide the light-emitting devices 10 into a plurality of groups.

For example, the light-emitting device 10 may be a light-emitting diode chip (LED chip) 20 including a light-emission cell, as illustrated in FIG. 3. The LED chip 20 may emit blue, green, red colors or the like according to a material of a compound semiconductor forming the LED chip 20. For example, a blue-color LED chip may have an active layer having a quantum well structure in which GaN and InGaN alternate with each other, and a p-type clad layer and an n-type clad layer, which are formed of a compound semiconductor including Al_{X}Ga_{Y}N_{Z}, may be formed at upper and lower portion of the active layer. According to the present embodiment, the light-emitting device 10 is the LED chip 20 but one or more embodiments of the present invention are not limited thereto. For example, the light-emitting device 10 may be an ultraviolet (UV) light diode chip, a laser diode chip, an organic LED chip, or the like.

As illustrated in FIG. 3, a plurality of the LED chips 20 are formed on a wafer 500 via a series of semiconductor fabricating processes. FIG. 3 does not illustrate a detailed structure of each LED chip 20, and only schematically illustrates a cathode electrode 21 and an anode electrode 22. Although the plurality of the LED chips 20 are formed on the same wafer 500, their optical characteristics may be different and a defect may occur according to manufacturing lots and positions on the wafer 500.

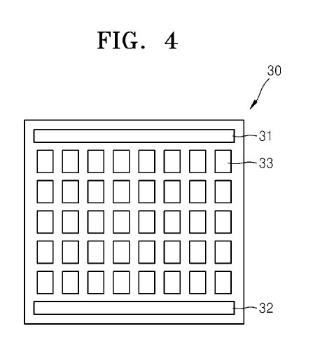

The light-emitting device 10 may be a multi-LED chip 30 including a plurality of light-emission cells 33, as illustrated in FIG. 4. Recently, light-emitting devices, in particular, LEDs, have been widely used for lighting applications, so that there is an increasing demand for a light-emitting device that has high brightness and can be manufactured with low costs. The multi-LED chip 30 is developed to meet such a demand and is manufactured as a chip formed of the light-emission cells 33 and cathode and anode electrodes 31 ad 32 that are to supply a current to the light-emission cells 33. Each of the light-emission cells 33 may have a plurality of LED structures that emit light. The light-emission cells 33 are disposed in parallel with respect to the cathode electrode 31 and the anode electrode 32. The light-emission cells 33 are driven by the current supplied via the cathode electrode 31 and the anode electrode 32. The multi-LED chip 30 may be a direct current (DC) type or an alternating current (AC) type.

The light-emitting device 10 may be an LED package formed in a manner that one or more LED chips 20 or one or more multi-LED chips 30 are packaged into a main body. In this regard, although the packaging is performed after electrical/optical inspections and visual inspection with respect to the LED chip 20 or the multi-LED chip 30 are performed, it is necessary to inspect again the electrical/optical characteristics and an outward appearance state of an LED package after the packaging is performed.

Referring to FIG. 5, an LED package 1 may include a light-emitting chip 7, e.g., one or more LED chips 20 or one or more multi-LED chips 30, and a package main body 2 on which the light-emitting chip 7 is mounted. The package main body 2 may include a conductive lead frame 5. The conductive lead frame 5 may include a mount portion 51 on which the light-emitting chip 7 is mounted, and first and second terminal units 52 and 53 that are electrically connected to the light-emitting chip 7 via bonding wires. For example, the first and second terminal units 52 and 53 may be connected to a cathode electrode and an anode electrode of the light-emitting chip 7 by using bonding wires 61 and 62, respectively. The first and second terminal units 52 and 53 are exposed to an outside of the package main body 2, and thus function as terminals for supplying a current to the light-emitting chip 7. In a case where a plurality of the LED chips 20 are packaged, all of the LED chips 20 may be disposed in parallel with respect to the first and second terminal units 52 and 53. The LED chips 20 are divided into a plurality of groups, each group having two or more LED chips 20 that are serially connected, and the plurality of groups may be disposed in parallel with respect to the first and second terminal units 52 and 53. The conductive lead frame 5 may be manufactured by performing a pressing operation or an etching operation on a conductive metal plate such as a copper plate, and an aluminum plate. A mold frame 4 may be combined with the conductive lead frame 5 via an insert injection mold process or the like. The mold frame 4 may be formed with, for example, an electrical insulating polymer. The mold frame 4 has a groove that exposes the mount portion 51, and the first and second terminal units 52 and 53. Thus, a cavity 3 is formed in the package main body 2. An inner surface 8 of the cavity 3 may be a reflective surface that reflects light emitted from the light-emitting chip 7, so as to allow the light to be emitted from the package main body 2. To do so, a material such as silver (Ag), aluminum (Al), platinum (Pt), titanium (Ti), chrome (Cr), copper (Cu), or the like having an excellent reflectance may be coated or deposited on the inner surface 8. In order to protect the light-emitting chip 7 and the bonding wires 61 and 62 from external factors, an encapsulation layer 9 that is formed of a light-transmitting resin such as silicon is formed in the cavity 3. The encapsulation layer 9 may include a phosphor for converting the light emitted from the light-emitting chip 7 into light having a desired color. The phosphor may be a single type or may be a plurality of types that are mixed according to a predetermined ratio.

The LED package 1 of FIG. 5 is exemplary, and thus, the scope of one or more embodiments of the present invention is not limited thereto. For example, one of an anode electrode pad and a cathode electrode pad of the light-emitting chip 7, e.g., the cathode electrode pad may be positioned at a lower portion of the light-emitting chip 7, so that the cathode electrode pad may be directly and electrically connected to the mount portion 51. That is, the mount portion 51 may also function as the second terminal unit 53. In this case, the anode electrode pad of the light-emitting chip 7 and the first terminal unit 52 are electrically connected by using the bonding wire 61. Also, the LED package 1 may not include the cavity 3. The LED package 1 may have a structure in which the light-emitting chip 7 is mounted on the mount portion 51 of the conductive lead frame 5, the light-emitting chip 7 and the first and second terminal units 52 and 53 are connected by using the bonding wires 61 and 62, and the light-transmitting encapsulation layer 9 is formed to cover the light-emitting chip 7 and the bonding wires 61 and 62. In this case, the package main body 2 may be formed as the conductive lead frame 5, and the mold frame 4 may be omitted. The LED package 1 may have one of various structures other than the aforementioned structures.

In general, an electrical open/short inspection with respect to the light-emitting device 10 is performed by using an electrical method. For example, a driving current, in particular, a current in a forward direction, may be supplied to the light-emitting device 10 and then a current that flows through the light-emitting device 10 may be measured. The measurement of the current may be indirectly performed by measuring a voltage applied to both ends of the LED chip 20. If a value of the measured current is equal to or greater than a predetermined reference range, the light-emitting device 10 may be determined as being a good product that does not have an electrical opening defect. Also, a weak current in a forward direction, e.g., a current in the range of several to several hundreds of micro-ampere, may be supplied to the light-emitting device 10. A diode structure only operates when a current equal to or greater than a predetermined threshold current is applied thereto, and thus, if a current less than the predetermined threshold current is applied to the diode structure, the current does not flow therethrough. However, if the diode structure is in an electrical short state, the current flows through the diode structure although the current is a weak current. Thus, if a current value is detected from the diode structure, it may be determined that the diode structure has an electrical short defect.

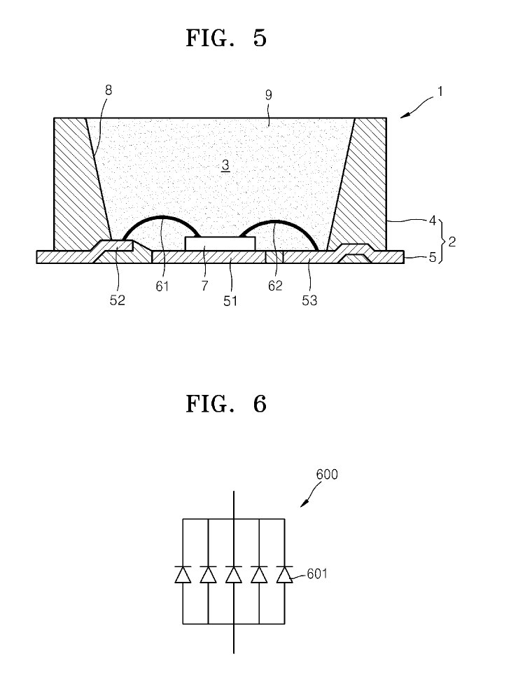

However, in the case of the multi-LED chip 30 shown in FIG. 4, it is difficult to ensure a reliability of an electrical open/short inspection according to the aforementioned electrical method. Hereinafter, a detailed description will now be provided for the case of FIG. 6 when a current is supplied to a multi-LED chip 600 formed of five LEDs 601 that are arrayed in parallel, and an electrical open inspection is performed thereon. In this case, a detected current value may vary according to how many LEDs from among the five LEDs 601 have an open defect.

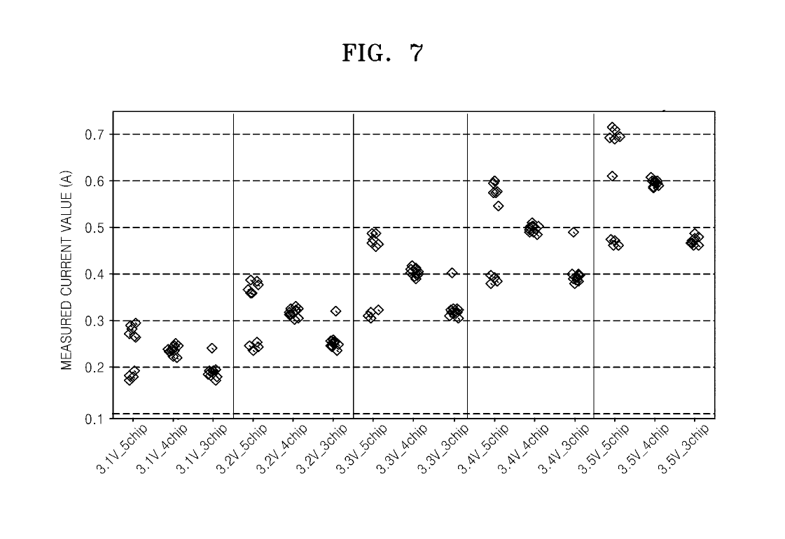

FIG. 7 is a graph of a result obtained by supplying a current to the multi-LED chip 600 of FIG. 6 and by measuring a current flowing through the multi-LED chip 600. On a horizontal axis of the graph, * of *V_#chip indicates a driving voltage, and # of *V_#chip indicates the number of LEDs 601 whose light emission is normal, i.e., the number of LEDs 601 that do not have an electrical open defect. For example, 3.1V_{—}5chip means that five LEDs 601 emit light at a driving voltage of 3.1V. The number of test materials in each case of the graph is 10. For example, it is assumed that the multi-LED chip 600 is treated as a good product if four or more LEDs 601 normally emit light. In this regard, a case in which a measured current value at the driving voltage of 3.1V is equal to or greater than about 0.2 A may be decided as a reference value. However, even in a case of 3.1V_{—}5chip, a measured current value of some chips may be equal to or less than 0.2 A, and even in a case of 3.1V_{—}3chip, a measured current value of some chips may be equal to or greater than 0.2 A. Thus, it is not possible to decide a reference current of a good product by referring only to the measured current value. This is the same in cases in which the driving voltage is 3.2V 3.3V 3.4V, and 3.5V.

The aforementioned difficulty in an electrical open inspection is the same in the case of the LED package 1 including the plurality of the LED chips 20 connected in parallel, or one or more multi-LED chips 30.

With respect to an electrical short inspection, it is necessary to arrange a highly expensive current detecting piece of equipment for supplying a weak current in the range of several to several hundreds of micro-ampere and for detecting it.

In order to solve the aforementioned problems, according to the present embodiment, the electrical open/short inspections are performed by using an image of the light-emitting device 10. Also, according to the present embodiment, in order to perform an optical inspection and electrical open/short inspections using the image by using one process, the light window 122 is arranged at the integrating sphere 120 for the optical inspection, and the image of the light-emitting device 10 is obtained via the light window 122. Also, according to the present embodiment, an outward appearance inspection may also be performed by using the image of the light-emitting device 10.

Hereinafter, a method of inspecting a light-emitting device will now be described according to an embodiment of the present invention.

For example, in order to inspect electrical/optical characteristics and a defect of an outward appearance, the multi-LED chip 30 is separated from a wafer via a dicing process and then is mounted on the table 401 shown in FIG. 1.

The probes 402 move as illustrated in FIG. 1 by solid lines and then contact the cathode electrode 31 and the anode electrode 32 of the multi-LED chip 30. When a current is supplied to the multi-LED chip 30 from the power source 403 via the probes 402, light is emitted from the multi-LED chip 30. The emitted light enters the integrating sphere 120 and is uniformly reflected from the inner wall of the integrating sphere 120, so that dispersion of light in the integrating sphere 120 is very uniform. The detector 110 collects light in the integrating sphere 120 and then detects an optical characteristic such as brightness, a wavelength, or the like of the multi-LED chip 30. The detected optical characteristic is delivered to the determination unit 300.

The determination unit 300 compares the detected optical characteristic with a predetermined reference optical characteristic, thereby determining a defect of the multi-LED chip 30. If the detected optical characteristic such as brightness, a wavelength, or the like exceeds an allowed range, the determination unit 300 may determine that the multi-LED chip 30 has a defect.

The optical characteristic inspection and an electrical open/short inspection may be simultaneously performed. To do so, a driving current is applied from the power source 403 to the multi-LED chip 30 via the probes 402. Light is emitted from the multi-LED chip 30 to the outside of the integrating sphere 120 via the light window 122. The emitted light is focused on the imaging device 211 of the image obtaining unit 200 by the lens 212. The frame grabber 220 converts an image, which has been photoelectrically converted by the imaging device 211, into digitized image information, and delivers the digitized image information to the determination unit 300. Also, a weak current is applied to the multi-LED chip 30, and the image obtaining unit 200 obtains an image at the weak current and then delivers the image to the determination unit 300. The image information is input to the image processing unit 310 of the determination unit 300, and the image processing unit 310 extracts an inspection image from the image information by performing a series of image processing processes including a noise filtering process, a tracing process, a threshold process, and the like.

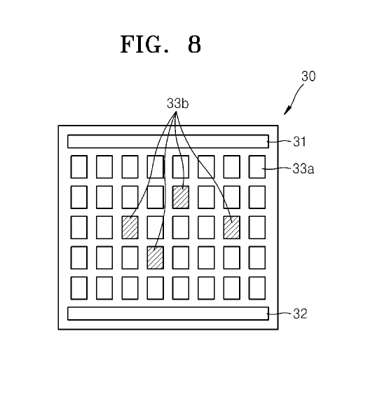

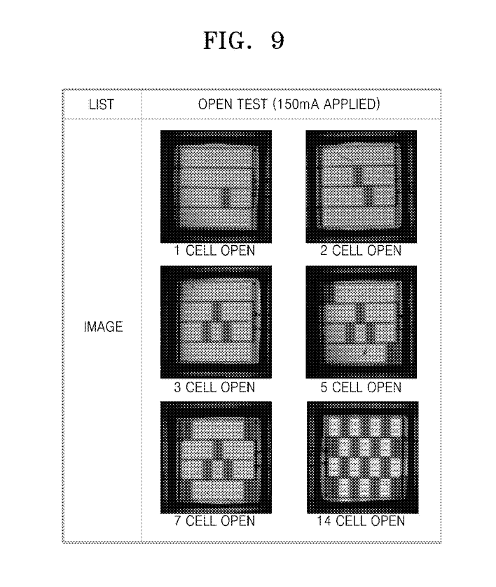

Although the optical characteristic is within the allowed range, if an electrical open/short defect is detected, the multi-LED chip 30 may be determined as being a defective product. For example, the determination unit 300 may compare the obtained image with a pre-stored reference image for the electrical open/short defect inspection by performing a mask matching process and then may determine existence of the electrical open/short defect. As illustrated in FIG. 8, although a normal driving current is applied to the multi-LED chip 30, if abnormal light-emission cells 33b that do not normally emit light exist from among the light-emission cells 33, the multi-LED chip 30 may be determined as a defective product. As illustrated in FIG. 8, in the inspection image, regions corresponding to the abnormal light-emission cells 33b that do not emit light or do not normally emit light are dim, compared to normal light-emission cells 33a that normally emit light, so that positions and the number of the abnormal light-emission cells 33b may be detected. The determination unit 300 may detect the number of the abnormal light-emission cells 33b by using brightness information of the inspection image, and may determine an electrical open defect when the number exceeds a reference number. FIG. 9 illustrates an example of images of the multi-LED chip 30 in which some cells do not emit light due to their electrical open defect. In the example of FIG. 9, a plurality of LEDs are serially connected in one cell, and if any one of the plurality of LEDs in one cell is electrically open, the entire cell does not emit light.

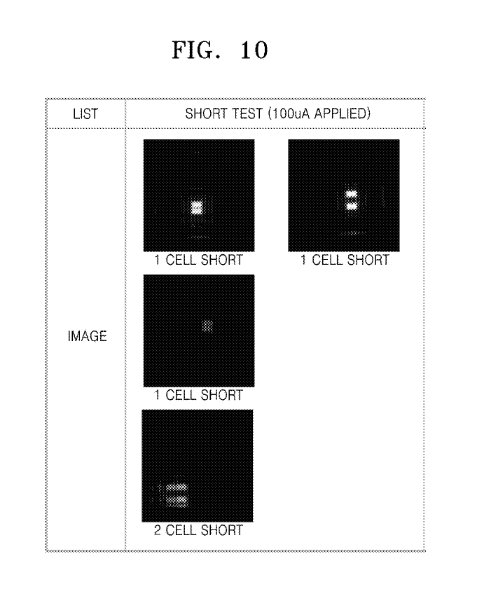

Also, when none of light-emission cells emits light in an image obtained by applying a weak current to the multi-LED chip 30, the multi-LED chip 30 may be determined as being a normal product that does not have an electrical short defect. However, even if there is an electrical short defect, some light-emission cells emit light. The determination unit 300 may detect the number of the light-emission cells 33 having an electrical short defect, by using the bright information of the inspection image, and if the number exceeds a reference number, the determination unit 300 may determine the multi-LED chip 30 as a defective product having the electrical short defect. FIG. 10 illustrates an example of images of the multi-LED chip 30 in which some light-emission cells emit light at a weak current due to an electrical short defect. In the example of FIG. 10, a plurality of LEDs are serially connected in one cell, and LEDs from among the plurality of LEDs in one cell, which have an electrical short defect, emit light.

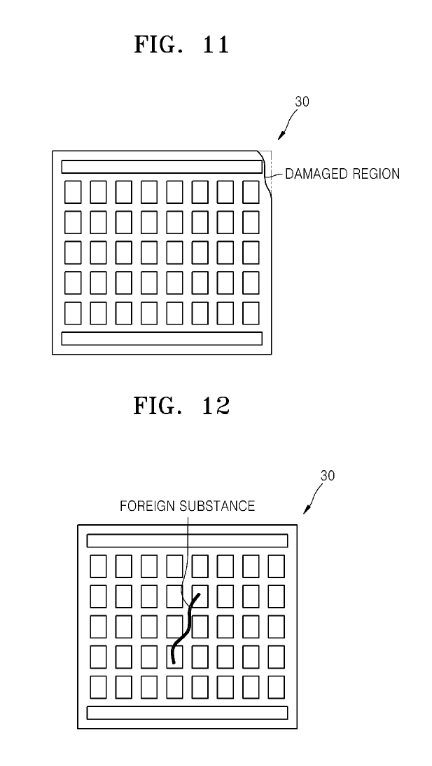

An outward appearance inspection may be performed by using an inspection image. For example, FIG. 11 schematically illustrates an example of an inspection image of the multi-LED chip 30 having a damaged region. FIG. 12 schematically illustrates an example of an inspection image of the multi-LED chip 30 having a foreign substance. The determination unit 300 may compare the inspection image with a pre-stored reference image for the outward appearance inspection by performing a mask matching process and then may determine a defect of an outward appearance of the multi-LED chip 30.

When the multi-LED chip 30 is determined as a defective product having a defect in its electrical/optical characteristics or in its outward appearance, the multi-LED chip 30 may be transported to a defect bin 501 by a transporting means (not shown). Also, the determination unit 300 may divide the multi-LED chip 30 into a plurality of groups according to its optical characteristics such as brightness and wavelength, and the plurality of groups may be transported to a plurality of bins, 502, respectively.

In an inspecting apparatus according to the related art, a defect in the electrical open/short inspection is determined based on a measured current value, so that the reliability of determination with respect to a good product may be low. Thus, it is necessary to complement an electrical open/short inspection by sequentially applying a driving current and a weak current to the light-emitting device 10 after the electrical open/short inspection is performed, and then by checking light-emission with the naked eye. However, this requires additional processes and thus, the entire process time is increased. Also, an inspection result based on the naked-eye check varies according to skills of an inspector, and thus, the reliability of the inspection result may be low. However, in the light-emitting device inspecting apparatus and method according to the one or more embodiments of the present invention, the electrical open/short inspection is performed in a manner that light-emission and the number of light-emission cells in response to a driving current and a weak current are detected by using an image of the light-emitting device 10, so that it is possible to accurately determine good products. Also, an automatic inspection is possible by the determination unit 300, so that uniformity and reliability of an inspection may be assured.

According to the light-emitting device inspecting apparatus and method, the image of the light-emitting device 10 that is necessary for the electrical open/short inspection is obtained via the light window 122 of the integrating sphere 120, so that the optical characteristic inspection and electrical open/short inspection may be performed in one process.

Also, in the inspecting apparatus according to the related art, an outward appearance inspection is performed with the naked eye after electrical/optical characteristic inspections are performed. To do so, when the optical characteristic inspection for the light-emitting device 10 is finished, the light-emitting device 10 is moved to another table (not shown), and then light is emitted to the light-emitting device 10 so as to check a defect of an outward appearance with the naked eye, and thus, an additional process time is required for the outward appearance inspection. Also, a result of the outward appearance inspection based on the naked-eye check varies according to the skills of an inspector, and thus, the reliability of the inspection result may be low. In a case of an inspecting apparatus that automatically performs the outward appearance inspection, in order to obtain an image of the light-emitting device 10, the inspecting apparatus moves away the measuring unit 100 including the integrating sphere 120 from the light-emitting device 10, or moves the light-emitting device 10 to another table (not shown) and emits light to the light-emitting device 10 by using a separate lighting source. Thus, an additional process time and equipment are necessary for the outward appearance inspection. However, in the light-emitting device inspecting apparatus and method according to the one or more embodiments of the present invention, an image of the light-emitting device 10 that is necessary for the electrical open/short inspection and the outward appearance inspection is obtained via the light window 122 of the integrating sphere 120, so that the optical characteristic inspection, the electrical open/short inspection, and the outward appearance inspection may be performed in one process. Thus, an additional table, a lighting device, and a process of moving the light-emitting device 10 for the outward appearance inspection are not necessary, so that it is possible to reduce the processing costs and processing time and to increase inspection reliability.

Although the aforementioned inspection process is described with respect to a process of inspecting the multi-LED chip 30, the scope of the one or more embodiments of the present invention is not limited thereto. For example, the light-emitting device 10 to be inspected may be the LED package 1 of FIG. 5. An optical characteristic inspection, an electrical open/short inspection, and an outward appearance inspection with respect to the LED package 1 may be performed in the same manner as described in the aforementioned inspection process. This will now be briefly described as below.

In order to determine a defect of an outer appearance and electrical/optical characteristics, the LED package 1 is mounted on the table 401 of FIG. 1. The probes 402 move as illustrated in FIG. 1 by solid lines and then contact the first and second terminal units 52 and 53 of the LED package 1. When a current is supplied to the light-emitting chip 7 from a power supplying unit (not shown) via the probes 402, light is emitted. The emitted light enters the integrating sphere 120 and the detector 110 collects light in the integrating sphere 120 and then detects an optical characteristic such as brightness, a wavelength, or the like of the LED package 1. The detected optical characteristic is delivered to the determination unit 300. The determination unit 300 compares the detected optical characteristic with a predetermined reference optical characteristic, thereby determining a defect of the LED package 1.

The image obtaining unit 200 obtains an image of the LED package 1 in response to a driving current and a weak current via the light window 122, converts the image into digitized image information, and delivers the digitized image information to the determination unit 300. The image information is input to the image processing unit 310 of the determination unit 300, and the image processing unit 310 extracts an inspection image by performing a series of image processing operations.

The determination unit 300 may determine an open/short defect, i.e., an abnormal electrical characteristic of the LED package 1 from the inspection image. The abnormal electrical characteristic of the LED package 1 may be incurred due to disconnection or a short of the bonding wires 61 and 62, or an electrical damage of the light-emitting chip 7 during a packaging procedure. When the electrical open/short defect occurs, it is possible to obtain an image similar to the images shown in FIGS. 9 and 10, so that a defect may be determined thereof.

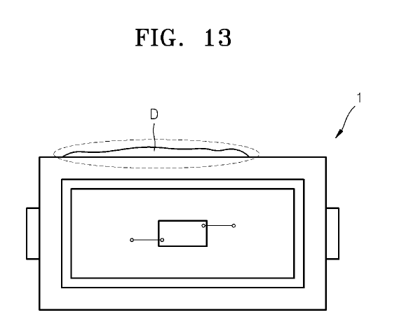

Damage, the existence of foreign substances, an over-applied resin of the encapsulation layer 9, or the like in the LED package 1 may be determined by comparing the inspection image with a pre-stored reference image. For example, when a resin that forms the encapsulation layer 9 overflows due to excessive injection, as illustrated in FIG. 13, a contour D exceeding an outline of the package main body 2 is shown in an inspection image. In this case, the determination unit 300 may determine the LED package 1 as being a defective product having a defective outward appearance due to an excessive resin of the encapsulation layer 9.

When the LED package 1 is determined as being a defective product having abnormal electrical/optical characteristics or outward appearance, the LED package 1 may be transported to the defect bin 501 by a transporting means (not shown). The determination unit 300 may divide the LED package 1 into a plurality of groups according to brightness and a wavelength, and the plurality of groups may be transported to the plurality of bins, 502, respectively.

The light-emitting device inspecting apparatus and method may also be applied to the LED chip 20 of FIG. 3. As described above, an optical characteristic inspection and a visual inspection with respect to the LED chip 20 may be performed in the same manner as described in the aforementioned inspection process. That is, although a normal driving current is applied, if light-emission does not occur, the LED chip 20 is determined as being a defective product having an electrical open defect, and if light-emission occurs in response to a weak current, the LED chip 20 is determined as being a defective product having an electrical short defect. Except this point, the optical characteristic inspection and the vision inspection with respect to the LED chip 20 may be performed in the same manner as the inspection process for the multi-LED chip 30.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A light-emitting device inspecting apparatus for inspecting a characteristic of a light-emitting device comprising one or more light-emission cells that emit light, the light-emitting device inspecting apparatus comprising:
a probing unit comprising a table on which the light-emitting device is mounted and probes that supply a current to the light-emitting device;
an image obtaining unit for obtaining an image of the light-emitting device; and
a determination unit for determining open/short defects of the light-emitting device by detecting light-emission of the one or more light-emission cells from brightness information of the image.

2. The light-emitting device inspecting apparatus of claim 1, further comprising a measuring unit comprising an integrating sphere that is positioned above the table and collects light emitted from the light-emitting device, and a detector that detects an optical characteristic of the light-emitting device,
wherein the measuring unit determines a defect of the optical characteristic of the light-emitting device based on the detected optical characteristic.

3. The light-emitting device inspecting apparatus of claim 2, wherein the determination unit divides the light-emitting device into a plurality of groups based on a result of the determination on the open/short defects, and the detected optical characteristic.

4. The light-emitting device inspecting apparatus of claim 2, wherein a light window is arranged at the integrating sphere, and
wherein the image obtaining unit obtains the image of the light-emitting device via the light window.

5. The light-emitting device inspecting apparatus of claim 4, wherein the determination unit comprises an image processing unit for generating an inspection image for an outward appearance inspection from the image, and
wherein the determination unit determines a defect of an outward appearance of the light-emitting device by comparing the inspection image with a pre-set reference image.

6. The light-emitting device inspecting apparatus of claim 4, wherein the image obtaining unit comprises:
an imaging device; and
a lens for focusing light on the imaging device after the light has passed through the light window.

7. The light-emitting device inspecting apparatus of claim 6, wherein the image obtaining unit comprises a light amount adjuster that is positioned ahead of the lens and adjusts the amount of light that has passed through the light window.

8. The light-emitting device inspecting apparatus of claim 1, wherein the light-emitting device comprises a multi-light emission chip in which a plurality of light-emission cells are arrayed.

9. The light-emitting device inspecting apparatus of claim 1, wherein the light-emitting device comprises a light-emitting diode (LED) package formed by packaging a plurality of LED chips.

10. The light-emitting device inspecting apparatus of claim 1, wherein the light-emitting device comprises a LED package formed by packaging one or more multi-light emission chips in which a plurality of light-emission cells are arrayed.

11. A method of inspecting a characteristic of a light-emitting device comprising one or more light-emission cells that emit light, the method comprising:
supplying a current to the light-emitting device;
obtaining an image of the light-emitting device; and
determining open/short defects of the light-emitting device by detecting light-emission of the one or more light-emission cells from brightness information of the image.

12. The method of claim 11, further comprising:
collecting light emitted from the light-emitting device by using an integrating sphere, and detecting an optical characteristic of the light-emitting device from the collected light; and
determining a defect of the optical characteristic of the light-emitting device based on the detected optical characteristic.

13. The method of claim 12, further comprising dividing the light-emitting device into a plurality of groups based on a result of the determination on the open/short defects, and the detected optical characteristic.

14. The method of claim 12, wherein the obtaining of the image comprises obtaining the image of the light-emitting device via a light window arranged at the integrating sphere.

15. The method of claim 14, further comprising:
generating an inspection image for an outward appearance inspection from the image, and
determining a defect of an outward appearance of the light-emitting device by comparing the inspection image with a pre-set reference image.

16. The method of claim 11, wherein the light-emitting device comprises a multi-light emission chip in which a plurality of light-emission cells are arrayed.

17. The method of claim 11, wherein the light-emitting device comprises a light-emitting diode (LED) package formed by packaging a plurality of LED chips.

18. The method of claim 11, wherein the light-emitting device comprises a LED package formed by packaging one or more multi-light emission chips in which a plurality of light-emission cells are arrayed.
